(19) United States
(12) Patent Application Publication
(10) Pub. No.: US 2026/0008365 A1
(43) Pub. Date: Jan. 8, 2026

(54) NON-ISOLATED BIDIRECTIONAL POWER CONVERTER WITH RESIDUAL CURRENT CONTROL

(71) Applicant: DCBEL INC., Montréal (CA)

(72) Inventors: Cedric SOMERS, Saint-Amable (CA); Paulo BARROSO, Brossard (CA); Marc-André FORGET, Saint-Lazare (CA)

(21) Appl. No.: 19/325,661

(22) Filed: Sep. 11, 2025

Related U.S. Application Data
(63) Continuation of application No. PCT/CA2024/051634, filed on Dec. 6, 2024.
(60) Provisional application No. 63/608,020, filed on Dec. 8, 2023.

(51) Int. Cl. B60L 53/22; B60L 53/62; H02H 3/16; H02M 1/00; H02M 1/32; H02M 3/158; H02M 7/219

(52) U.S. Cl. CPC B60L 53/22; B60L 53/62; H02H 3/16; H02M 1/0009; H02M 1/007; H02M 1/0074; H02M 1/0077; H02M 1/32; H02M 3/158; H02M 7/219

(57) ABSTRACT

A non-isolated bidirectional high-voltage direct current battery charger is made compatible with a ground-fault circuit interrupter (GFCI) at the DC output by adapting the power converter to control, in response to voltage or current sensors, a net current difference between forward current and return current to remain below a threshold of the GFCI. This can be done without compromising safety in the case of actual ground faults.

### CROSS-REFERENCE TO RELATED APPLICATIONS

This patent application is a continuation of PCT application serial number PCT/CA2024/051634, filed Dec. 6, 2024, designating the US, now pending that claims priority to U.S. provisional patent application Ser. No. 63/608,020 filed on Dec. 8, 2023.

### FIELD

The present disclosure relates to power converters, such as storage battery chargers for electric vehicles (EV), and more particularly relates to non-isolated bidirectional battery chargers suitable for use with EV to home and/or solar power to EV to home applications.

### BACKGROUND

In a typical ground-referenced battery charger, there is a risk that a charge current might find a path to ground. This may pose a risk of electrical shock and/or short-circuit conditions if there is an equipment failure or misuse, which may lead to personal injury, fire hazard and/or property damage. Such injury or damage might be exacerbated with higher voltages such as those used to charge the types of storage batteries typically found in electric vehicles. The allowable amount of the residual current (leakage current) is governed by specific standards and regulations designed to ensure the safety of both the electric vehicle its user. For example, for a North American standard for EVs and plug-in hybrid electric vehicles (PHEVs), a residual DC current greater than 20 mA may trigger the interruption of the charging process resulting in disconnecting the charging system from the vehicle. Some standards may set a level of acceptable residual current to much less than 20 mA.

Electric vehicles (EVs) use chargers having galvanic isolation by means of an isolation transformer that adds weight and cost. The primary need for isolation is to satisfy safety requirements when operating at higher voltage levels. 20 mA of current flowing through person to ground at the voltage of the EV battery can be fatal. Therefore, there exists a need to improve the weight and volume of an EV charger while maintaining safety. Applicant has proposed in U.S. Pat. No. 11,811,300 to avoid the need for a low frequency isolation transformer at the connection to the AC grid by performing conversion of the DC power in the DC-to-DC converter to high-frequency AC power that is then coupled through a much smaller, lighter and less costly isolation transformer. The solution proposed in U.S. Pat. No. 11,811,300 is for an EV charger and is described as being connected to a single phase of AC power. While this is indeed an improvement over grid frequency galvanic isolation, this approach still involves additional power conversion components and an isolation transformer that reduce energy and weight efficiency.

Since non-isolated chargers lack galvanic isolation, they may typically employ operational methods allowing to suppress common-mode leakage currents to ground in order to avoid nuisance tripping of residual current device (RCD). Typically, electromagnetic interference (EMI) filters may be used to reduce high-frequency common-mode leakage currents, however, they struggle with filtering low-frequency common-mode voltages that can drive significant low-frequency common-mode current though parasitic capacitance and the EMI filtering capacitors between battery terminals (also referred to as Y capacitors) to protective earth which is connected to the vehicle chassis during charging. In the article by D. Zhang, D. Cao, J. Huber, J. Everts and J. W. Kolar, titled “Nonisolated Three-Phase Current DC-Link Buck-Boost EV Charger With Virtual Output Midpoint Grounding and Ground Current Control,” published in IEEE Transactions on Transportation Electrification, vol. 10, no. 1, pp. 1398-1413 March 2024, DOI: 10.1109/TTE.2023.3282978, a system is described that suppresses common-mode currents using a virtual grounding control (VGC) of the DC output voltage midpoint, in order to compensate for low-frequency common-mode voltage components, ensuring almost zero low-frequency common-mode voltage, which reduces low-frequency common-mode leakage currents. This enables further a direct connection to the DC output midpoint to protective earth, where a ground current control (GCC) achieves near-zero low-frequency common-mode leakage current, preventing nuisance RCD tripping, and allows the direct grounding of the DC output midpoint. In the reference, the residual current sensor is located on the input side of the AC-to-DC converter, i.e., on the AC-side, and it used to measure a sum of the three-phase mains currents, allowing to determine the total ground current by detecting any imbalance in the sum of the currents flowing through the three-phase conductors. Overall, the VGS/GCC solution uses active control methods to manage common-mode voltages and ground currents, providing flexibility and precise leakage current management without a direct ground connection. However, since the “virtual ground” is constantly floating, this solution requires constant active balancing of common-mode voltage on the DC side of the AC-to-DC converter.

### SUMMARY

Applicant has discovered a number of problems when attempting to operate an EV bidirectional charger without galvanic isolation and while using a ground-fault circuit interrupter (GFCI) at the DC vehicle port. The first problem is that the residual current in the DC connection to the EV, even when the insulation of the EV battery management system (BMS) and EV battery is not impaired, the GFCI can detect residual currents. These residual currents would also appear if galvanic isolation were involved, however, in the case of galvanic isolation, such residual currents are not a problem since there is no GFCI required. The source of the residual currents can not only be the result of a low frequency variation in the DC power, but also the result of a sudden change in charge voltage.

A second problem arises from the loss of a benefit of a grid frequency isolation transformer in the case of split-phase power. An isolation transformer for split-phase power is connected to L1, L2 and N (each 120 V AC phase and neutral) on the grid side and then can be connected on the converter side to only L1 and L2 with the power converter operating on a single phase of 240 V AC. When this isolation transformer is not present, power can still be drawn from the grid as single phase 240 V from L1 and L2, but when in an island mode in which the converter is supplying AC power to the home, the lack of a separate neutral would mean that 120 V loads would receive no power. Thus multiple-phase, neutral referred converters can be required, making the charger more expensive.

In the solution relying on the connection to neutral, which is proposed by the applicant, the midpoint of the DC output may be connected to the neutral point of the AC mains, which means that the neutral wire, which is connected to ground at the main service panel acts as the reference point for the DC output midpoint. Therefore, by connecting the DC midpoint to the neutral, the common-mode voltage is directly referenced to the neutral point, which is already grounded. This may help significantly reducing the potential difference between the DC midpoint and ground, thereby minimizing common-mode leakage currents, which makes it simpler comparatively to the virtual ground solution proposed in the Zhang et al. reference, as it relies on the existing neutral-to-ground connection. Since there is no electronic switching system (ESS), no photovoltaic (PV) panel connected to the DC bus, there are no external ground currents, which could create additional common-mode imbalance. Furthermore, the fine adjustment of the of common-mode voltages is performed on the DC-to-DC side of the AC-to-DC converter.

Therefore, a non-isolated high-voltage direct current battery charger may be made compatible with a ground-fault circuit interrupter (GFCI) at the DC output by adapting the power converter to control, in response to voltage or current sensors, a net current difference between forward current and return current to remain below a threshold of the GFCI. This may be done without compromising safety in the case of actual ground faults.

A conventional GFCI device that opens the circuit as soon as residual current between the forward and return current differs by more than allowed threshold, which meets safety standards and regulatory requirements of currently available charging protocols, may be tripped as described above during normal charging.

Applicant has found that this problem may be resolved by responding to a measurement of the forward and return currents from the EV (or other storage battery) to modulate at least one of them so that the transitory residual current never reaches a given threshold, such as, for example, 20 mA.

In an embodiment, an electric vehicle (EV) battery charger includes: at least two non-isolated AC-to-DC power converters; at least one DC-to-DC power converter connected to an output of each AC-to-DC power converter and configured to provide an EV charging DC output having a positive terminal and a negative terminal with a reference to a signal ground; at least two residual current sensors configured to measure at least one of a current difference between current flowing through the positive terminal versus current flowing through the negative terminal, or a voltage difference between a voltage across the positive terminal and the negative terminal versus a voltage across at least one of the positive terminal or the negative terminal and a chassis ground; and a controller connected to the residual current sensor and to the DC-to-DC power converter and configured to provide an adjustment signal to the EV charging DC output in response to the residual current sensor measurement, wherein the controller in combination with the DC-to-DC converter are configured, when the EV charging DC output is connected to an EV, to prevent a current difference between current flowing through the positive terminal and current flowing through the negative terminal from exceeding a predetermined threshold associated with a ground fault circuit interrupter (GFCI) connected to the EV charging DC output.

In an embodiment, a non-isolated high-voltage charging circuit includes: an input line and an output line; a primary switch connected between the input line and a primary node; a secondary switch connected between the primary node and a signal ground; a primary inductor connected between the primary node and a secondary node; a secondary inductor connected between the secondary node and the output line; a tertiary inductor connected between the secondary node and the signal ground; at least one sensor connected to at least one of the input line or the output line; and a controller having at least one input connected to the at least one sensor, and at least two outputs respectively connected to the primary switch and the secondary switch.

The controller may include a proportional-integral-derivative (PID) controller connected to a pulse-width modulation (PWM) modulator. Moreover, the PID controller may include a primary PID controller responsive to a battery voltage and a difference voltage, and a secondary PID controller responsive to a command current and a difference current.

The charging circuit may further include: a primary capacitor connected between the input line and the signal ground; a secondary capacitor connected between the tertiary inductor and the signal ground; a tertiary capacitor connected between the output line and the signal ground; and a fourth capacitor connected between the output line and a vehicular chassis or Earth ground.

The charging circuit may further include: a second input line and a second output line; a second primary capacitor connected between the second input line and the signal ground; a second primary switch connected between the second input line and a second primary node; a second secondary switch connected between a second primary node and the signal ground; a second primary inductor connected between the second primary node and a second secondary node; a second secondary inductor connected between the second secondary node and the second output line; a second tertiary inductor and a second secondary capacitor connected in series between the second secondary node and the signal ground; a second tertiary capacitor connected between the second output line and the signal ground; and a second sensor connected between the second output line and a charger chassis ground.

### BRIEF DESCRIPTION OF THE DRAWINGS

The present disclosure is described by way of example in the following detailed description of embodiments with reference to the appended drawings, in which:

FIG. 1 is a schematic block diagram of an EV charger, which is known in the art and uses an isolation transformer between the grid and the power converter;

FIGS. 2A and 2B are schematic illustrations of an EV charging environment;

FIG. 3 is a schematic block diagram of a non-isolated controlled EV charger in accordance with an embodiment of the present disclosure;

FIG. 4 is a schematic diagram of a non-isolated alternating current to direct current charger in accordance with an embodiment of the present disclosure;

FIG. 5 is schematic block diagram of a non-isolated EV charger having two AC-to-DC converters connected to each of split-phase AC grid L1, L2 and N terminals, and two DC-to-DC converters, in which ground-fault current is prevented at the DC connection to the EV by separating the supply of forward current from the supply of return current in the DC connection to the EV, measuring residual current and controlling the balance of forward current with respect to return current to maintain a safe supply of DC power to the EV without using any isolation transformer or wireless coupling;

FIG. 6 is a schematic diagram of a DC-to-DC converter for the non-isolated alternating current to direct current charger of FIG. 4;

FIG. 7A schematically illustrates an embodiment two AC-to-DC power converters each connected to a respective phase of split-phase AC grid using an LCL filter. Each AC-to-DC converter further comprises a T-type inverter/rectifier connected to a DC-to-DC converter stage, such as, for example, the one schematically illustrated in FIG. 6;

FIG. 7B schematically illustrates another embodiment of two AC-to-DC power converters, each connected to a respective phase of split-phase AC grid, i.e., L1 and L2, and using an LCL filter, as well as another configuration of two half-bridge back ends connected to the DC-to-DC converter stage, such as, for example, a DC-to-DC converter schematically illustrated in FIG. 6;

FIG. 7C schematically illustrates another embodiment of two AC-to-DC power converters shown in FIG. 7B with a pair of secondary inductors in two LCL filters being coupled;

FIG. 7D schematically illustrates another embodiment of three AC-to-DC power converters, each connected to a respective phase of split-phase AC grid, i.e., L1, L2, and L3, using an LCL filter. Each AC-to-DC converter may further comprise a connection to a T-type inverter/rectifier;

FIG. 7E schematically illustrates another embodiment of two AC-to-DC power converters, each connected to a respective phase of split-phase AC grid, i.e., L1 and L2, using LCL filters, which may comprise one primary inductor and a pair of secondary inductors that may be magnetically coupled. Each LCL filter may comprise a connection to a half-bridge provided by a T-type inverter/rectifier;

FIG. 7F schematically illustrates another embodiment of two AC-to-DC power converters each connected to a respective phase of split-phase AC grid power using coupled inductors and two half-bridge back ends connected to a DC-to-DC converter stage that has two half-bridges and a shared coupled inductor at its output to an EV; and

FIG. 8 is a schematic diagram of a control system for the non-isolated direct current to direct current converter of FIG. 1.

### DETAILED DESCRIPTION

A ground-fault circuit interrupter (GFCI) device as used herein means a residual-current device (RCD) configured to measure a difference between a forward current delivered to a device being charged and a return current received from the device. The measured difference should be substantially nil unless the device includes non-linear energy storage elements and/or there is some leakage current to ground. Alternating current (AC) electricity having a frequency of about 60 Hertz (Hz) and a current above about 20 milliamperes (mA), depending on the particular environment, may be enough in some cases to potentially cause cardiac arrest and/or serious harm if the duration is too great. Thus, many GFCI devices are designed to open the protected circuit once a measured difference between the forward and return currents exceeds about 20 mA.

For example, if the current difference sensitivity of a GFCI is about 20 mA as installed at the connection to an electric vehicle's (EV) direct current (DC) charging port, any current difference greater than 20 mA might cause needless tripping of the GFCI, and thereby cause needless or excessively frequent interruption of the DC charging process.

Applicant has attempted to add a ground-fault circuit interrupter (GFCI) at the DC EV charging port of a conventional isolated multi-level (e.g. 5-level) DC EV charger, for example using relatively low frequency power switches as is the case with the PUC-5 design, and found that the typical sensitivity of the GFCI of about 20 mA installed at the connection to the EV will cause tripping of the GFCI and thus interruption of the DC charger quite frequently. There has thus been found to be a problem in using GFCI protection with a conventional DC charger.

The Applicant has found that measuring the charging voltage and/or current fed to the charging port or battery for determining whether a projected difference between forward current and return current is likely to exceed a given threshold, such as a 20 mA threshold, and using this measurement in an active control feedback loop associated with non-isolated power converter, for example in a direct-current to direct-current (DC-to-DC) voltage converter associated with the non-isolated power converter, to actively control the supplied voltage to the battery, may allow for a non-isolated DC charger to avoid tripping the GFCI device during normal charging operations. In the event that there is an actual ground fault, the active control feedback loop might attempt to reduce voltages to limit residual current to below the given threshold, however, if the active feedback cannot succeed, the GFCI will prevent harm or damage should an actual failure or mis-use provide an unintended path to ground, such as on the side of a device being charged like an electric vehicle (EV).

For example, if the sensitivity of the GFCI is about 20 mA as installed at the connection to an EV's DC charging port (delivering DC power within a range of about 350 V to about 1000 V), any current ripple greater than 20 mA might cause excessive tripping of the GFCI, and thereby cause frequent interruption of the DC charging process.

An embodiment of the present disclosure combines a non-isolated DC charger with a GFCI, to control a net current difference between forward current and return current to remain below a threshold sensitivity of the GFCI.

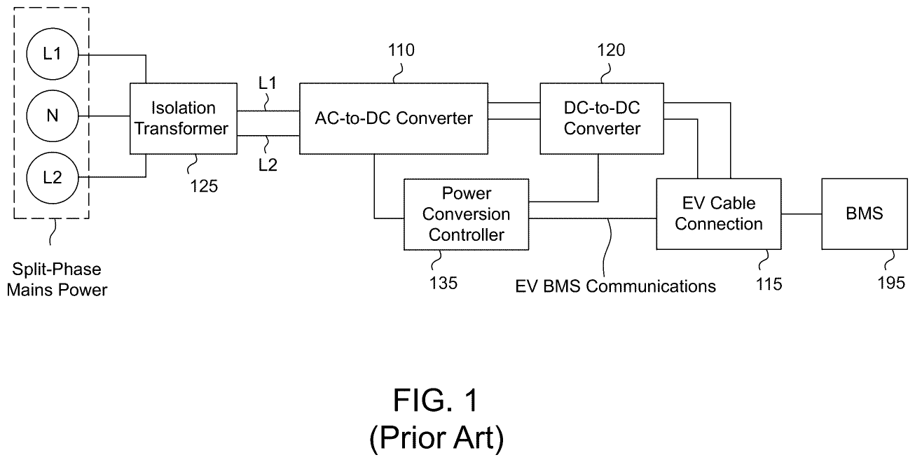

FIG. 1 schematically illustrates a power conversion circuit of an EV charger known in the prior art comprising a split-phase AC input from the split-phase mains power, including three terminals, namely, terminals L1 and L2 for two “hot” wires that are 180 degrees out of phase, each carrying 120 V, as well as the neutral terminal N. The AC input may be connected an isolation transformer 125 that provides galvanic isolation and may function by using a magnetic coupling to transfer electrical power between its primary and secondary windings while maintaining electrical isolation, and as a result, protecting a user from an electric shock. Isolation transformer 125 may be further connected to an AC-to-DC converter 110 with its output further supplied to a DC-to-DC converter 120, which then supplies DC power to a battery of an electric vehicle (EV) through EV cable connection 115. The latter is used by a battery management system (BMS) 195 of an EV to communicate with a power conversion controller 135 of an EV charger, which may control the operation of AC-to-DC converter 110 and/or DC-to-DC converter 120 to charge or discharge a battery of an EV. It may be appreciated by a person skilled in the art that AC-to-DC converter 110, DC-to-DC converter 120, isolation transformer 125, power conversion controller 135 installed on-board of an EV. In this case, EV cable connection 115 may be internal to an EV.

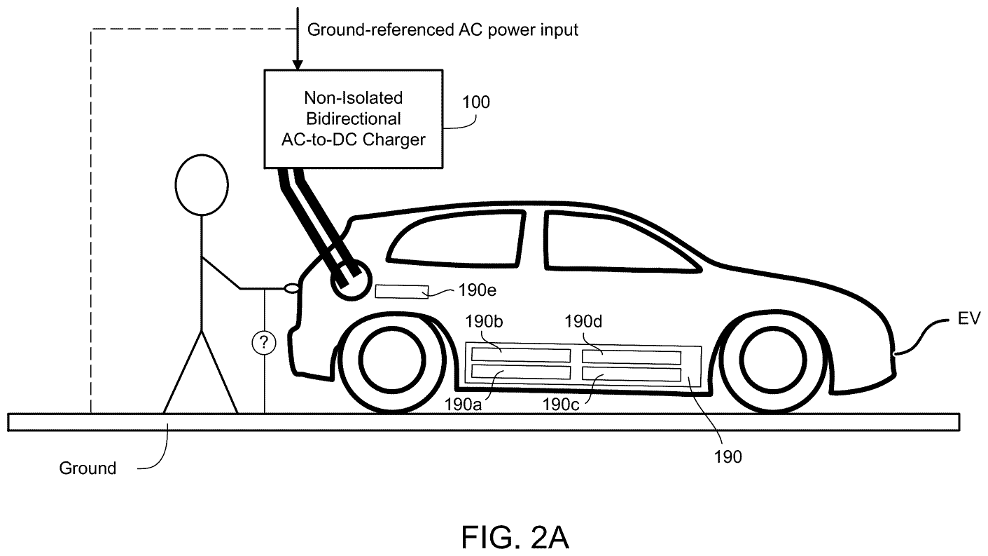

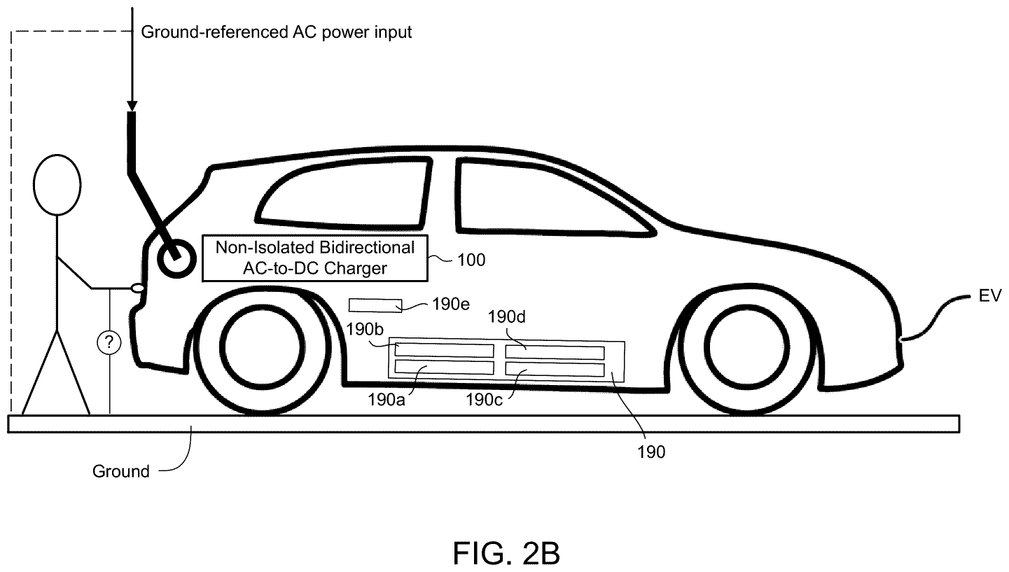

FIG. 2A illustrates the context of an embodiment in which an EV is DC charged using an off-board grounded or non-isolated charger 100 supplied from, for example, AC mains power. The EV has an on-board storage battery 190 and is shown to be parked on the ground. It may be appreciated that battery 190 may comprise a plurality of battery cells, such as, for example, cells 190a/190b/190c/190d, which may be appropriately spaced within battery 190 and may be connected in series and/or in parallel allowing to achieve desired voltage and capacity. When a person touches the chassis or body of the car, a fault in the vehicles could allow DC current to find a path to ground due to the change in the capacitance to ground, while BMS of an EV may connect/disconnect some of the battery cells during charging/discharging process.

FIG. 2B schematically illustrates an alternative embodiment presented in FIG. 2A, in which an EV is DC charged using an on-board grounded or non-isolated charger 100 receiving AC power directly from the AC mains.

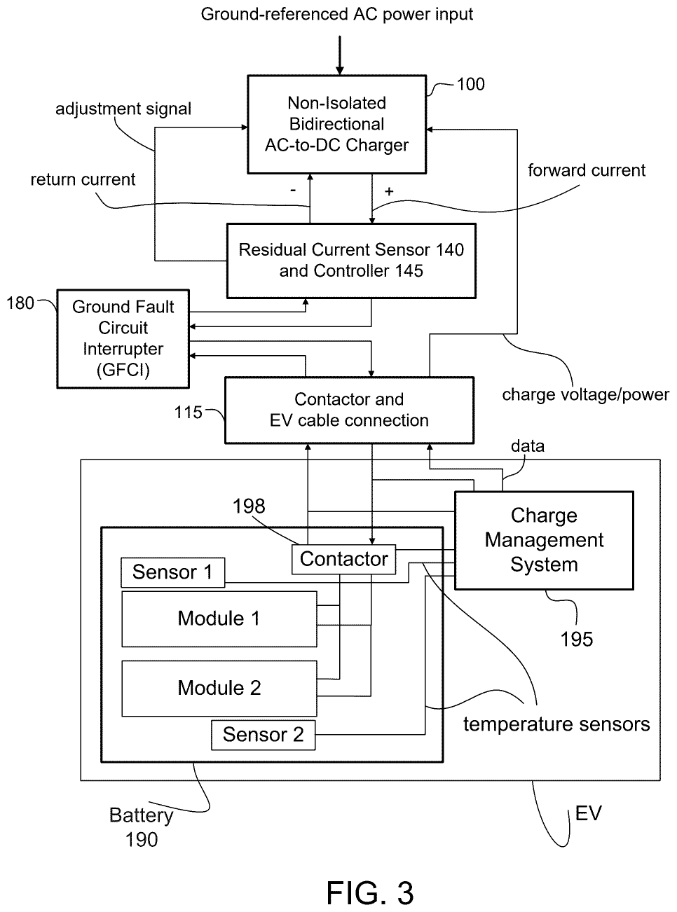

FIG. 3 illustrates a block diagram of an embodiment in which a controller 145 of non-isolated bidirectional AC-to-DC charger 100 is responsive to an adjustment signal generated by a residual current sensor 140, when the latter may detect a leakage current above a predefined threshold, for example, in the residual DC current standard, is about 20 mA. The residual current sensor 140 and controller 145 measure the forward and return currents in the electrical connection to the EV. A GFCI device 180 may be placed either before or after the residual current sensor 140 and controller 145 to independently assess residual current and interrupt power flowing to the EV in the event that the residual current exceeds an acceptable threshold. A power contactor and EV cable connection 115 connects the high-voltage DC power between the EV and the bidirectional charger 100. The contactor 115 is controlled by the charger 100 when the charger is ready to connect or disconnect from the battery 190. The charger 100 may comprise at least two AC-to-DC power converters, each of which may be connected to at least one DC-to-DC power converter and, when charger 100 may operate as a rectifier, it may receive a charge voltage signal from BMS 195 of EV's battery and responds to this signal to produce a suitable output DC voltage. This may allow the BMS 195 to control the battery charging conditions for the EV's battery 190.

It is known that an EV battery may comprise groups of connected battery cells (such as, for example, cells 190a/190b/190c/190d shown in FIG. 2A or modules as shown in FIG. 3) that each provide the battery's output voltage. A charge management component of the BMS 195 may measure temperatures of each group.

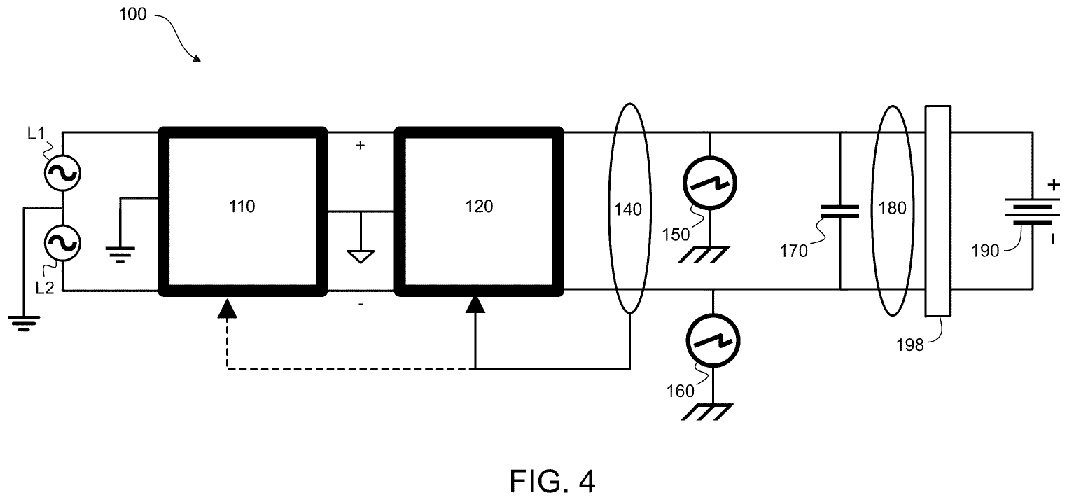

In the embodiment of FIG. 4, non-isolated bidirectional AC-to-DC charger 100 connectable to split-phase AC grid may include at least two AC-to-DC power converters 110, each connected to a respective phase of a split-phase AC grid, and at least one DC-to-DC power converter 120, wherein each output of an AC-to-DC converter 110 may be connected to a DC-to-DC power converter 120, or at least one half-bridge thereof (positive and/or negative half-bridge), via a signal ground line and at least one of a positive voltage line or a negative voltage line with respect to the signal ground. DC-to-DC power converter 120 may provide a relatively positive output line and a relatively negative output line through a residual current sensor 140. The residual current sensor 140 measures a net residual current between the relatively positive output line versus the relatively negative output line. The adjustment signal generated using the residual current sensor 140 may control AC-to-DC power converter 110 (dashed line) or, as shown, DC-to-DC converter 120.

A first voltage sensor 150 may be connected between the relatively positive output line and a chassis ground, and a second voltage sensor 160 may be connected between the relatively negative output line and the chassis ground. A capacitor 170 may be connected between the relatively positive output line and the relatively negative output line.

The relatively positive output line and the relatively negative output line may also pass through a GFCI device 180 before connecting, for example through a contactor or relay 198, to respective positive and negative terminals of battery 190 to be charged or discharged. The inclusion of the CFCI device 180 may ensure that residual current and potentially dangerous ground fault current will not cause harm in the case of a malfunction in the residual current sensor 140 and controller 145. At least one DC-to-DC power converter 120 may actively control its output signal over the relatively positive output line and the relatively negative output line using at least one of the first voltage sensor or the second voltage sensor, to achieve a low-ripple output signal that does not needlessly trip GFCI 180 under normal operation.

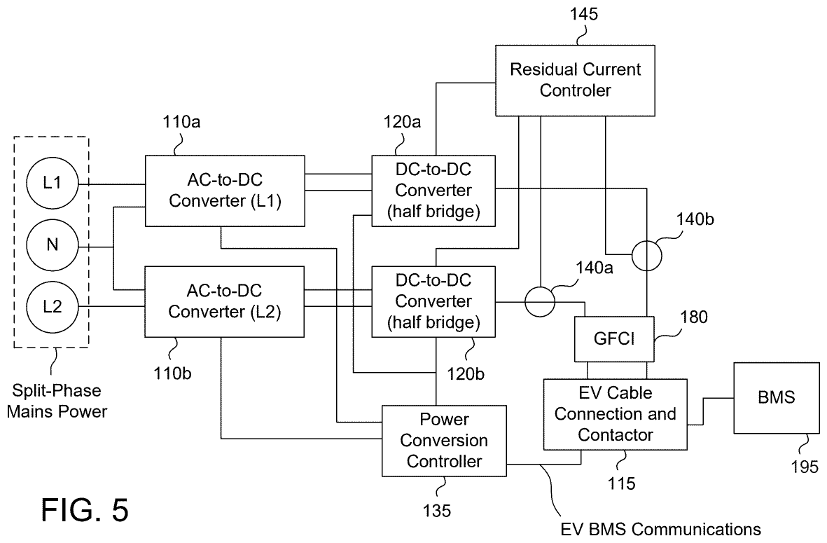

FIG. 5 schematically illustrates more detailed view of an embodiment of a non-isolated bidirectional EV charger 100 comprising two non-isolated AC-to-DC converters 110a/110b, each of which may be connectable to a corresponding split-phase AC terminal, i.e., L1 or L2, and to neutral N. In this example, non-isolated AC-to-DC converters 110a/110b may be connected to L1/L2 terminals. Furthermore, each AC-to-DC converter 110a/110b may be connected to a positive/negative half-bridge 120a/120b of DC-to-DC converter 120, respectively. Each half-bridge 120a/120b of DC-to-DC converter 120 may be connected to a residual current sensor 140 (here illustrated as two sensors 140a/140b, respectively) that may further be connected to the residual current controller 145 connected to the output lines of DC-to-DC converter 120. The ground-fault current is prevented at the DC connection to an EV by separating the supply of forward current to maintain a safe supply of DC power to an EV without using any isolation transformer or wireless coupling. Furthermore, power conversion controller 145 may be connected to both AC-to-DC converters 110a/110b, as well as to half-bridges 120a/120b of DC-to-DC converter 120. Power conversion controller 135 receives communication from BMS 195 through EV cable connection 115, to control and negotiate charging/discharging process. While not shown in FIG. 5, the BMS 195 also provides the DC connection to the storage battery, for example through a contactor 198. Furthermore, an EV charger may comprise a GFCI 180, which may be connected to residual current sensor 140, which, in this example, is provided by sensors 140a/140b. GFCI 180 may also constitute a part of EV cable connection 115.

It may be appreciated by a person skilled in the art that if non-isolated bidirectional AC-to-DC charger 100 is installed on board of an EV, such as, for example, illustrated in FIG. 2B, EV cable connection 115 may be internal to the EV. Moreover, AC-to-DC converters 110a/110b may use either separate converters or may use motor drive inverters of the EV. The DC-to-DC converters 120a/120b may be added components along with power conversion controller 135 and residual current controller 145, so that GFCI protection functions properly on board of the EV.

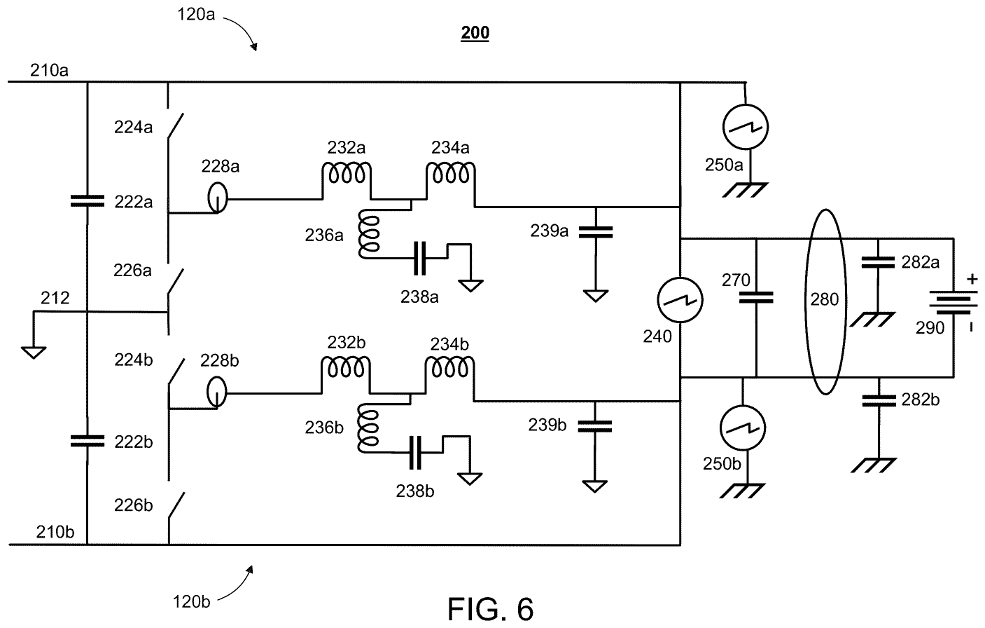

Turning to FIG. 6, a circuit topology of non-isolated DC-to-DC converter 120 is indicated generally by the reference numeral 200. The circuit topology 200 of DC-to-DC converter 120 may include at least one half-bridge that receives from a non-isolated AC-to-DC converter such as 110a/110b of FIG. 5, inputs including at least one voltage line 210 and/or a signal ground 212. In an embodiment, the circuit topology 200 of non-isolated DC-to-DC converter 120 may include two half-bridges including a top half-bridge respectively indicated by reference numeral suffix “a” and a bottom half bridge respectively indicated by reference numeral suffix “b”. Each half-bridge 120a/120b respectively may include a capacitor 222a/222b disposed between its at least two inputs, a primary switch 224a/224b connected to its higher potential input, a secondary switch 226a/226b connected to its lower potential input, a primary node connected between the primary switch and the secondary switch and may include a current sensor 228a/228b connected to the primary node. For example, current sensor 228a/228b may be an integrated current sensor using differential measurement without a ferrite core.

Each half-bridge 120a/120b may further include a primary inductor 232a/232b connected between the primary node or the current sensor 228a/228b and a secondary node, respectively, and a secondary inductor 234a/234b connected between the secondary node and an output line. Primary inductor 232a/232b and secondary inductor 234a/234b, respectively, may share a same core. A tertiary inductor 236a/236b may be connected in series with a secondary capacitor 238a/238b, respectively, between the secondary node and the signal ground. A voltage sensor 250a/250b may be connected between the output line and a chassis ground. The output line may be connected to a positive or a negative terminal of a DC battery 290.

Top half-bridge 120a may have its input line 210a connected to the positive input from the AC-to-DC converter 110a of FIG. 5, and bottom half-bridge 120b may have its input line 210a connected to the negative input from the AC-to-DC converter 110b of FIG. 5. The corresponding components of top half-bridge 120a and bottom half-bridge 120b may each be substantially the same as described above, so duplicate description may be omitted.

This two half-bridge embodiment may further include a voltage sensor 240 connected between the output line of the top half bridge (top output line) and the output line of the bottom half bridge (bottom output line), a tertiary capacitor 270 connected in parallel with the voltage sensor between the output lines of the top half bridge and the bottom half-bridge, and a GFCI 280 inductively coupled to the output lines of the top half-bridge and the bottom half-bridge. Moreover, the output line of the top half-bridge may be connected to the positive terminal of the battery 290, and the output line of the bottom half-bridge may be connected to the negative terminal of the battery 290.

In an embodiment, circuit topology 200 of non-isolated DC-to-DC converter 120 may include a top input line 210a; a top output line connectable to a positive terminal of a DC battery 290; a top primary switch 224a connected between the top input line 210a and a top primary node; a top secondary switch 226a connected between the top primary node and a signal ground; a top primary inductor 232a connected between the top primary node and a top secondary node; a top secondary inductor 234a connected between the top secondary node and the top output line; a top tertiary inductor 236a connected between the top secondary node and the signal ground; and a top sensor 250a connected between the top output line and a chassis ground.

This embodiment may also include a bottom input line 210b; a bottom output line connectable to a negative terminal of the DC battery 290; a bottom primary switch 224b connected between the bottom input line 210b and a bottom primary node; a bottom secondary switch 226b connected between the bottom primary node and the signal ground; a bottom primary inductor 232b connected between the bottom primary node and a bottom secondary node; a bottom secondary inductor 234b connected between the bottom secondary node and the bottom output line; a bottom tertiary inductor 236b connected between the bottom secondary node and the signal ground; and a bottom sensor 250b connected between the bottom output line and the chassis ground.

This embodiment may also include a top primary capacitor 222a connected between the top input line 210a and the signal ground, a top secondary capacitor 238a connected between the top tertiary inductor 236a and the signal ground, a top tertiary capacitor 239a connected between the top output line and the signal ground; a bottom primary capacitor 222b connected between the bottom input line 210b and the signal ground, a bottom secondary capacitor 238b connected between the bottom tertiary inductor 236b and the signal ground, a bottom tertiary capacitor 239b connected between the bottom output line and the signal ground.

In this embodiment, each of the sensors 250a and 250b may be voltage sensors, although current sensors may be adapted in alternate embodiments. Moreover, another voltage sensor 240 may be connected between the top output line and the bottom output line. In addition, another capacitor may be connected between the top output line and the bottom output line.

A residual current sensor 280 may be coupled to the top output line and the bottom output line. While the sensor is illustrated by an oval, in a manner suggestive of a coil used for sensing residual AC current, the sensor used for sensing DC current is typically of a different structure. The battery 290 may be a rechargeable multi-cell battery of about 400 V to 1000 V connected to the top output line and the bottom output line via a user-accessible charging port of an EV. Moreover, the top output line may be connected through a top tertiary capacitor 282a to the chassis ground, and the bottom output line may be connected through a bottom tertiary capacitor 282a to at least one of the chassis ground or to Earth ground, without limitation. Typically, the EV charger cable will provide earth ground to the EV.

In an embodiment, the top primary inductor 232a and the bottom primary inductor 232b may have a shared core. Similarly, the top secondary inductor 234a and the bottom secondary inductor 234b may have a shared core. Each shared core may be ferrite or magnetic. Moreover, each of the inductors 232a, 232b, 234a, and 234b may share a same core. In addition, the tertiary inductors 236a and 236b may similarly have a shared core, which may be the same or different from the cores of the other inductors.

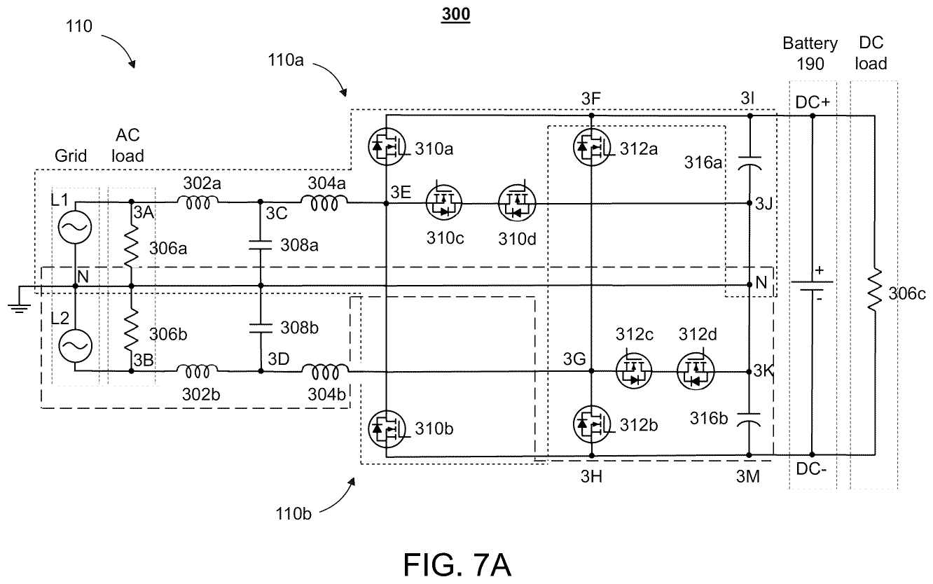

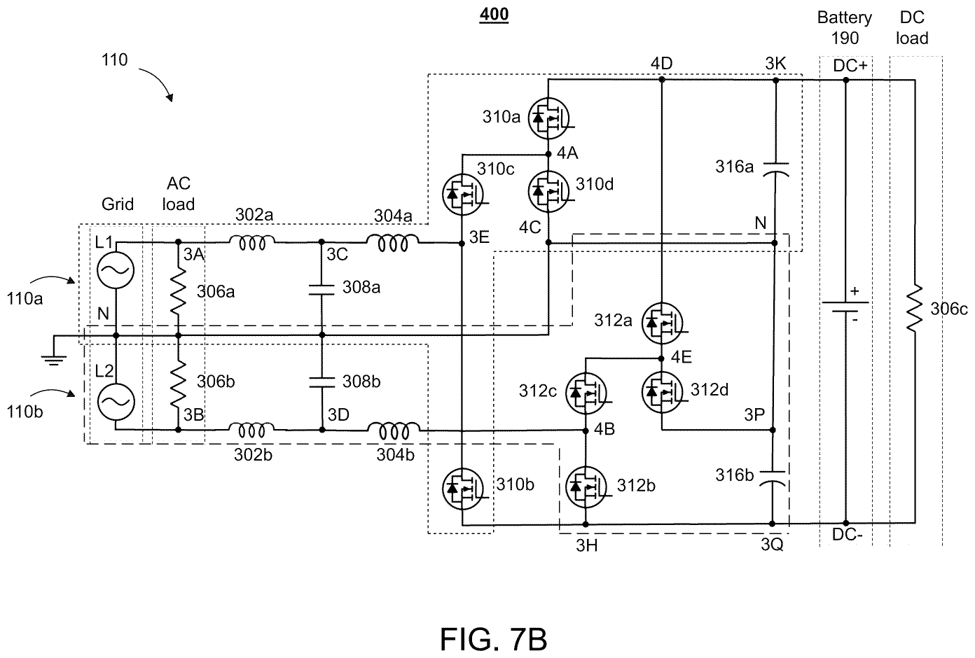

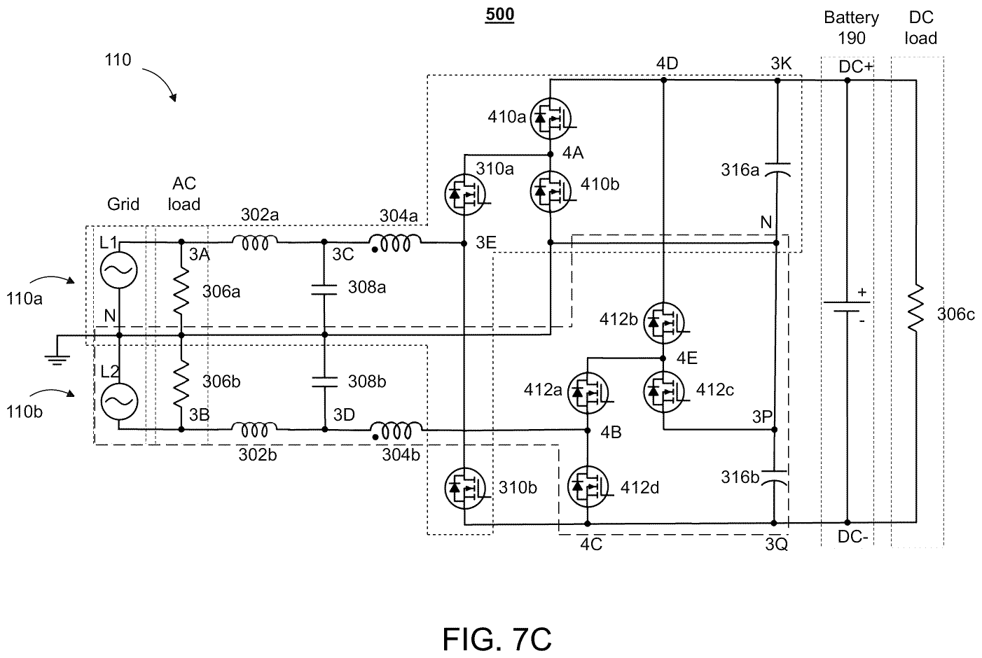

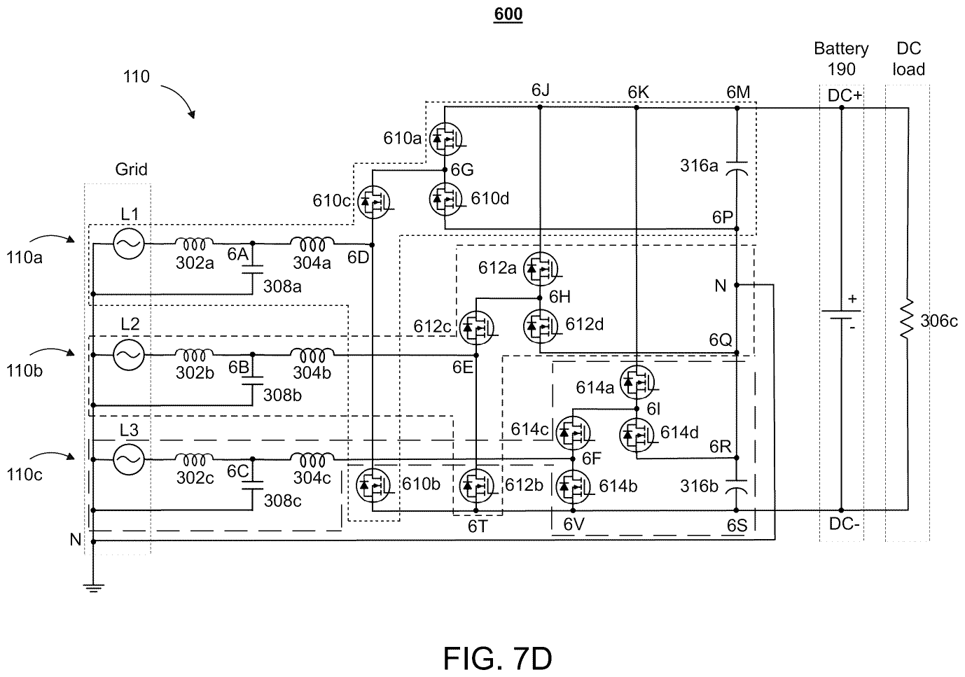

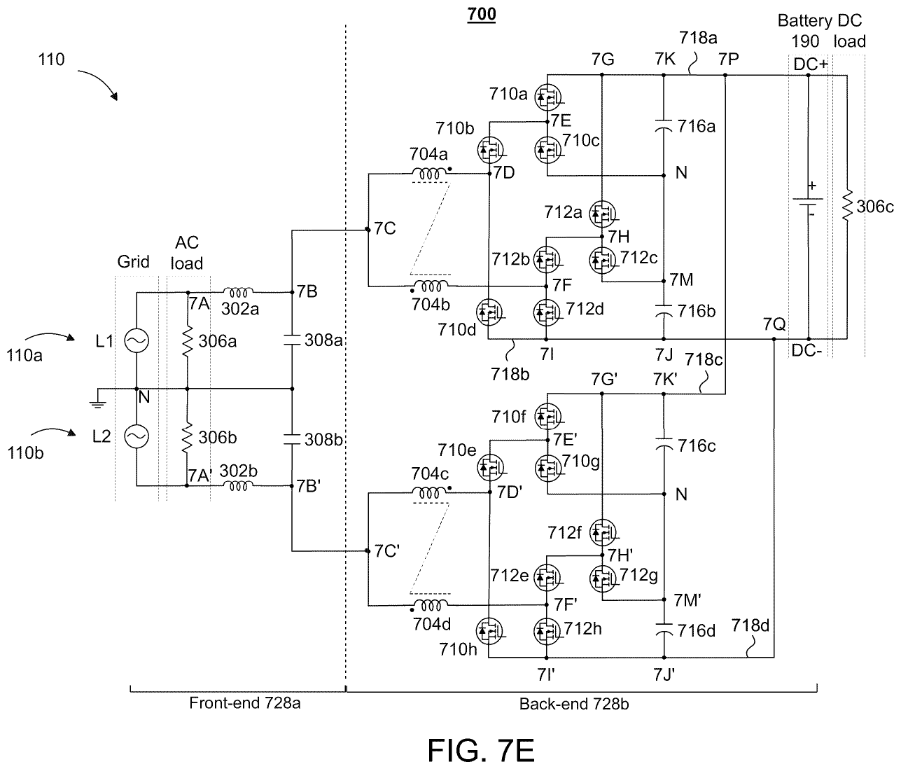

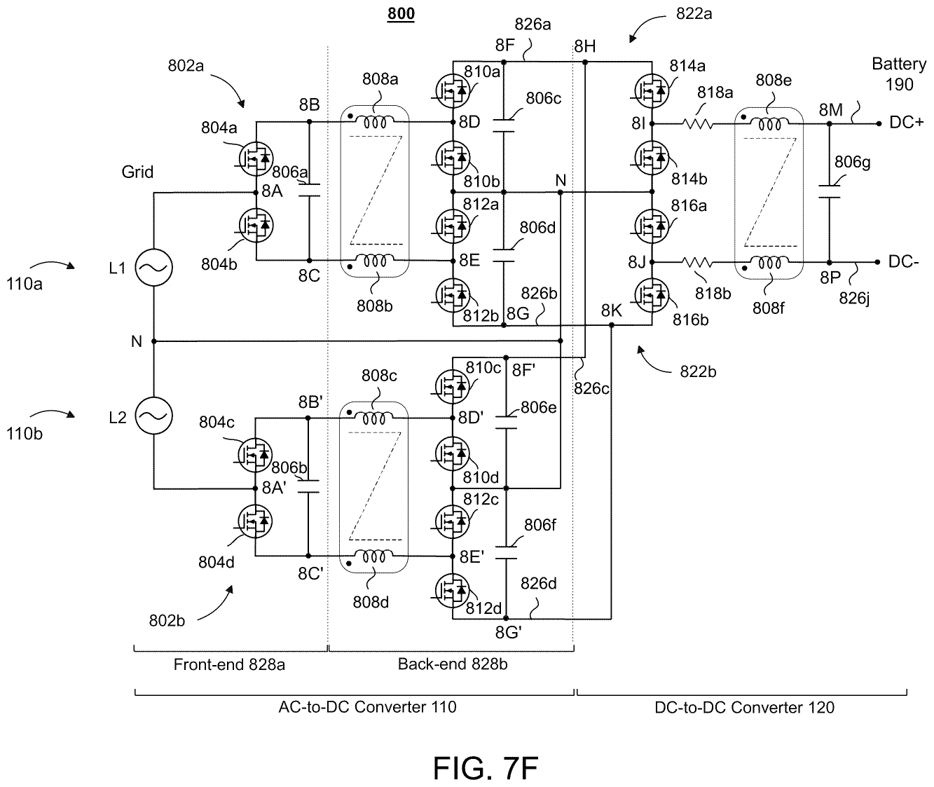

FIG. 7A schematically illustrates an embodiment of circuit topology 300 of one of the embodiments of non-isolated AC-to-DC converter 110, which may be provided by two AC-to-DC converters 110a/110b schematically illustrated in FIG. 5. Circuit topology 300 of AC-to-DC converter 110 may comprise T-cell switch topology.

Circuit topology 300 of non-isolated AC-to-DC converter 110 may comprise AC load 306a and AC load 306b, which may be connected to a respective phase of split-phase AC grid. In this embodiment, an AC load 306a may be connected to terminal L1, i.e., between node 3A and neutral N, and AC load 306b may be connected to terminal L2, i.e., between node 3B and neutral N. Top primary inductor 302a may be connected in series with AC load 306a, i.e., between nodes 3A and 3C, and bottom primary inductor 302b may be connected in series with AC load 306b and in parallel to primary inductor 302a, i.e., between nodes 3B and 3D. Capacitor 308a may be connected in series with top primary inductor 302a and may be connected in parallel to AC load 306a, i.e., between node 3C and neutral N. Similarly, capacitor 308b may be connected in series with bottom primary inductor 302b and top primary inductor 302a, as well as in parallel to AC load 306b, i.e., between node 3D and neutral N. It may be appreciated that capacitors 308a/308b may also be provided by flying capacitors.

Furthermore, a top secondary inductor 304a may be connected in series top primary inductor 302a, i.e., between nodes 3C and 3E, and bottom secondary inductor 304b may be connected in series with bottom primary inductor 302b and may be connected in parallel with top secondary inductor 304a, i.e., between nodes 3D and 3F. It may be appreciated by a person skilled in the art that the inductance of primary inductors 302a/302b may be greater, same, or smaller comparatively to the inductance of secondary inductors 304a/304b. It may also be appreciated that each of primary inductors 302a/302b, capacitors 308a/308b, and secondary inductors 304a/304b, associated with a respective phase of the AC grid, i.e., L1 and L2, respectively, may form an LCL-filter, which may be used to reduce high order harmonics caused by semiconductor switching.

It may be appreciated that, in case of the split-phase or two-phase system, i.e., systems wherein voltage waveforms of each respective phase are 180 degrees and 90 degrees out of phase, respectively, the AC power may be drawn from both phases simultaneously (i.e., from L1 and L2 at the same time), which may allow for higher power transfer without increasing current, which reduces losses and heating in conductors (i.e., helps balancing the load, such as the one provided by an EV battery 190), or from each phase individually. Drawing power from only one phase (i.e., L1 or L2) may be suitable where only 120 V (i.e., for North American standard) connection is required. Also, DC power may be supplied back to the grid or a load (for example, any household appliances) to both lines (i.e., L1 and L2) or just one, depending on the requirement.

As further illustrated in FIG. 7A, high-side switch 310a may be connected between nodes 3E and 3F, low-side switch 310b may be connected in series with high-side switch 310a, i.e., between nodes 3E and 3H. Switches 310c/310d may be connected in series between nodes 3E and 3J. Furthermore, high-side switch 312a may be connected between nodes 3F and 3G, low-side switch 312b may be connected in series with high-side switch 312a, i.e., between nodes 3H and 3G. Switches 312c and 312d may be connected in series between nodes 3G and 3K. It may be appreciated that switches 310c/310d, as well as switches 312c/312d may allow for bidirectional power flow.

Furthermore, in an embodiment, a capacitor 316a may be connected in parallel to high-side switches 310a/312a, i.e., between nodes 3I and 3J, and a capacitor 316b may be connected in parallel to low-side switches 310b/312b, i.e., between nodes 3K and 3M. It may also be appreciated that the high-side and low-side outputs of non-isolated AC-to-DC converter 110 illustrated in FIG. 7A may further be connected respectively to the positive and negative terminals, which may be connected to load 306c. The circuits of FIGS. 7A through 7F can be operated as active power rectifiers for AC to DC conversion in which the DC side 306c is a load, and they can be operated as power inverters for DC to AC power conversion in which the DC side 306c is a source. In all embodiments, the DC side can be another conversion stage or it can be a load or source. In some embodiments, it may comprise a battery 190, while in others the DC load or source need not be a battery 190.

It may be appreciated that switches mentioned in this description may be provided by controllable switches, such as, for example, metal-oxide-semiconductor field-effect transistors (MOSFETs), insulated-gate bipolar transistors (IGBTs), diodes, other suitable controllable switches known in the art, or a combination of thereof.

FIG. 7B illustrates schematically another embodiment of circuit topology 400 of non-isolated AC-to-DC converter 110, which may comprise T-cell switch topology. Similarly to the circuit topology 300 illustrated in FIG. 7A, in this example, each AC-to-DC converter 110a/110b may comprise a connection to one of two terminals, i.e., L1 and L2, wherein each terminal may correspond to a phase of the split-phase AC grid, and to neutral N. Each AC-to-DC converter 110a/110b may further comprise an AC load 306a/306b, a primary inductor 302a/302b, a capacitor 308a/308b, which may be provided by a flying capacitor, and a secondary inductor 304a/304b, respectively. AC-to-DC converter 110a may further comprise a high-side switch 310a, which may be connected between nodes 4A and 4D, a low-side switch 310b, which may be connected between nodes 3E and 3H, switch 310c, which may be connected between nodes 3E and 4A, and switch 310d, which may be connected in parallel to switch 310c, i.e., between nodes 4A and 4C. It may be appreciated that switches 310c/310d may allow for bidirectional power flow.

As further illustrated in FIG. 7B, AC-to-DC converter 110b may also comprise high-side switch 312a, which may be connected between nodes 4D and 4E, a low-side switch 312d, which may be connected between nodes 3H and 4B, switch 312c, which may be connected between nodes 4B and 4E, and switch 312d, which may be connected between nodes 4E and 3P. AC-to-DC converter 110a may further comprise capacitor 316a, which may be connected in parallel to switches 310a/310d, i.e., between node 3K and neutral N, and AC-to-DC converter 110b may further comprise capacitor 316b, which may be connected in parallel to switches 312b/312c, i.e., between node 3P and 3Q.

It may also be appreciated that the high-side and low-side outputs of AC-to-DC converter 110 illustrated in FIG. 7B may further be connected respectively to the positive and negative terminals, i.e., DC+ and DC−, of the EV battery 190, which may be connected to load 306c.

FIG. 7C depicts an alternative embodiment of circuit topology 400 schematically illustrated in FIG. 7B provided by circuit topology 500, wherein a pair of secondary inductors 304a/304b may be magnetically coupled.

FIG. 7D schematically illustrates another embodiment of a circuit topology 600 of non-isolated AC-to-DC power converter 110, which may be provided by three AC-to-DC power converters 110a/110b/110c, which may be connected to a respective phase of three-phase AC grid (in this example, to L1, L2, and L3, respectively). Similarly to the description provided for circuit topologies 400 in FIG. 7B and 500 in FIG. 7C, AC-to-DC power converter 110 may comprise primary inductors 302a/302b/302c, secondary inductors 304a/304b/304c, which may be connected in series with primary inductors 302a/302b/302c, respectively, capacitor 308a/308b/308c, which may be connected between primary inductor 302a/302b/302c and secondary inductor 304a/304b/304c, i.e., between node 6A/6B/6C and neutral N. It may further comprise high-side switch 610a/612a/614a, which may be connected between nodes 6G and 6J, 6H and 6J, 6I and 6K, respectively, low-side switch 610b/612b/614b, which may be connected between nodes 6D and 6T, 6E and 6T, 6F and 6V, respectively, switch 610c/612c/614c, which may be connected between nodes 6D and 6G, 6E and 6H, 6F and 6I, respectively, switch 610d/612d/614d, which may be connected between nodes 6G and 6P, 6H and 6Q, 6I and 6R, respectively. It may be appreciated that pairs of switches 610c/612c/614c and 610d/612d/614d, respectively, may allow for bidirectional power flow. It may also be appreciated that the high-side and low-side outputs of AC-to-DC converter 110 illustrated in FIG. 7C may further be connected respectively to the positive and negative terminals, i.e., DC+ and DC−, of the EV battery 190, which may be connected to load 306c.

As further illustrated in FIG. 7D, capacitor 316a may be connected in parallel to switches 610a/610d, i.e., between nodes 6M and 6P, and capacitor 316b may be connected in parallel to switches 614c/614b, i.e., between nodes 6R and 6S.

It may be appreciated that, in case of the three-phase system, i.e., a system wherein three voltage waveforms are 120 apart from one another, a bidirectional AC-to-DC power converter 100 may be connected to all three phases (L1, L2, and L3). Evenly drawing power from all three phases may allow to balance the load, allowing for more efficient and stable charging. In some cases, a power converter may be connected between two phases (i.e., L1 and L2, L2 and L3, or L1 and L3), or be connected to a single phase, depending on the power required for charging. As well, like for the split-phase system, DC power may be supplied back to the grid or a load (for example, any household appliances) to all lines (i.e., L1, L2, and L3), two lines, or just one.

FIG. 7E illustrates another embodiment of circuit topology 700 of non-isolated AC-to-DC converter 110, which may comprise two AC-to-DC power converter 110a/110b, each connected to a respective split-phase AC grid at the front-end 728a. In this example, AC-to-DC power converter 110a may be connected to terminal L1, and AC-to-DC power converter 110b may be connected to terminal L2. The high-side and low-side outputs of back-end 728b may further be connected respectively to the positive and negative terminals, i.e., DC+ and DC−, of the EV battery 190, which may be connected to a load 306c.

In an alternative embodiment illustrated in FIG. 7E, circuit topology 700 of AC-to-DC converter 110 may comprise AC load 306a and AC load 306b, which may be connected to a respective phase of split-phase AC grid and neutral N. In this embodiment, an AC load 306a of AC-to-DC converter 110a may be connected to terminal L1, i.e., between node 7A and neutral, and AC load 306b of AC-to-DC converter 110b may be connected to terminal L2, i.e., between node 7A′ and neutral. Primary inductor 302a of AC-to-DC converter 110a may be connected in series with AC load 306a, i.e., between nodes 7A and 7B, and primary inductor 302b of AC-to-DC converter 110b may be connected in series with AC load 306b, i.e., between nodes 7A′ and 7B′. Furthermore, capacitor 308a may be connected in series with primary inductor 302a and parallel to AC load 306a, i.e., between node 7B and neutral, and capacitor 308b may be connected in series with bottom primary inductor 302b and parallel to AC load 306b, i.e., between node 7B′ and neutral. It may be appreciated that capacitors 308a/308b may be provided by flying capacitors.

As further illustrated in FIG. 7E, back-end 728b of AC-to-DC converter 110a may comprise a pair of inductors 704a/704b, which may be magnetically coupled. A shared core may be ferrite or magnetic. It may further comprise high-side switches 710a/712a, which may be connected between nodes 7E and 7G, 7H and 7G, respectively. It may further comprise low-side switches 710d/712d, which may be connected between nodes 7D and 7I, 7F and 7I, respectively. AC-to-DC converter 110a may also comprise switches 710b/712b, which may be connected between nodes 7D and 7E, 7F and 7H, respectively, and switches 710c/712c, which may be connected between node 7E and neutral N, the nodes 7H and 7M, respectively. It may be appreciated that switches 710b/710c and 712b/712c may allow for bidirectional power flow.

It may be appreciated that back-end 728b of AC-to-DC power converter 110a may further comprise capacitor 716a, which may be connected in parallel to switches 710a/710c, i.e., between node 7K and neutral N, and capacitor 716b, which may be connected in parallel to switches 712b/712d, i.e., between nodes 7M and 7J.

Also, as illustrated in FIG. 7E, back-end 728b of AC-to-DC power converter 110b may comprise a pair of inductors 704c/704d, which may be magnetically coupled and may have a shared core. A shared core may be ferrite or magnetic. It may further comprise high-side switches 710f/712f, which may be connected between nodes 7E′ and 7G′, 7H′ and 7G′, respectively. It may further comprise low-side switches 710h/712h, which may be connected between nodes 7D′ and 7I′, 7F′ and 7I′, respectively. It may also comprise switches 710e/712e, which may be connected between nodes 7D′ and 7E′, 7F′ and 7H′, respectively, and switches 710g/712g, which may be connected between node 7E′ and neutral N, the nodes 7H′ and 7M′, respectively. It may be appreciated that switches 710e/712e and 710g/712g may allow for bidirectional power flow.

It may also be appreciated that the high-side and low-side outputs of non-isolated AC-to-DC converter 110 illustrated in FIG. 7E may further be connected respectively to the positive and negative terminals, i.e., DC+ and DC−, of the EV battery 190, which may be connected to a load 306c, which may be connected to load 306c.

It may be appreciated that back-end 728b of AC-to-DC converter 110b may further comprise capacitor 716c, which may be connected in parallel to switches 710f/710g, i.e., between node 7K′ and neutral N, and capacitor 716d, which may be connected in parallel to switches 712e/712h, i.e., between nodes 7M′ and 7J′.

Furthermore, it may be appreciated that high-side line 718a and low-side line 718b of the of AC-to-DC power converter 110a may be connected to high-side line 718c and low-side line 718d of AC-to-DC converter 110b at nodes 7P and 7Q, respectively.

FIG. 7F schematically illustrates another embodiment of a circuit topology 800 of non-isolated AC-to-DC power converter 110, wherein each AC-to-DC converter 110a/110b may comprise a half-bridge 802a/802b, which is connected at front end 828a to a respective phase, i.e., L1 or L2, of split-phase AC grid, respectively. The output of each half-bridge 802a/802b may be further connected to non-isolated DC-to-DC converter 120, which may comprise two half-bridges 822a/822b. For example, in case, when charger may operate in a rectifier mode, the power conversion circuit may take as an input AC power from at least one phase and may produce an output DC power, which may then be supplied to the battery of an EV through positive DC terminal of an EV battery 190, allowing the return current to flow through negative DC terminal of an EV battery 190, i.e., schematically illustrated as DC+ and DC−.

In an alternative embodiment illustrated in FIG. 7F, half-bridge 802a of front-end 828a of AC-to-DC power converter 110a may be connected to split-phase terminal L1 and may comprise a pair of series connected switches 804a/804b, i.e., a top switch 804a, which may be connected between nodes 8A and 8B, and a bottom switch 804b, which may be complementary to switch 804a and may be connected between nodes 8A and 8C. Similarly, half-bridge 802b of front-end 828a of AC-to-DC power converter 110b may be connected to split-phase terminal L2 and may comprise a pair of series connected switches 804c/804d, i.e., a top switch 804c, which may be connected between nodes 8A′ and 8B′, and bottom switch 804d, which may be complementary to switch 804c and may be connected between nodes 8A′ and 8C′. It may be appreciated that switches 804a/804b and switches 804c/804d may be controlled to turn on and turn off in synchronization with the AC input waveform, allowing to control the input AC current supplied to the circuit from L1 and/or L2 terminals, when AC-to-DC power converter operates as a rectifier, or allowing to control the AC current output to the terminals L1 and/or L2, when AC-to-DC power converter operates as an inverter.

As further illustrated in FIG. 7F, half-bridge 802a of front-end 828a of AC-to-DC converter 110a may comprise primary capacitor 806a, which may be connected in parallel to a pair of switches 804a/804b, i.e., between nodes 8B and 8C. Similarly, half-bridge 802b of front-end 828a of AC-to-DC converter 110b may comprise primary capacitor 806b, which may be connected in parallel to a pair of switches 804c/804d, i.e., between nodes 8B′ and 8C′. It may be appreciated that capacitors 806a/806b may be provided by flying capacitors.

Furthermore, half-bridge 802a of back-end 828b of AC-to-DC converter 110a may further comprise a top inductor 808a, which may be connected between nodes 8B and 8D, and a bottom inductor 808b, which may be connected between nodes 8C and 8E. Similarly, half-bridge 802b of back-end 828b of AC-to-DC converter 110b may comprise a top inductor 808c, which may be connected between nodes 8B′ and 8D′, and bottom inductor 808d, which may be connected between nodes 8C′ and 8E′.

It may be appreciated that each pair of inductors, i.e., inductors 808a/808b and inductors 808c/808c, may be magnetically coupled and may have a shared core. Each shared core may be ferrite or magnetic. It may be appreciated that a pair of inductors 808a/808b and a pair of inductors 808c/808d may isolate the primary side of front end 828a from the rest of the power conversion circuit, which may provide galvanic isolation and may allow stepping up or stepping down the voltage level depending on the operation mode of said power conversion circuit 800.

It may be appreciated that the magnetic coupling between inductors 808a/808b and inductors 808c/808d, as well as other coupled inductors that are mentioned in this description, may, for example, be higher than 50%, but may not necessarily reach 100%. The magnetic coupling between the inductors constituting a coupled inductor may be withing a range of 80% to 90%, allowing for efficient operating on the power conversion circuit 800 described herein.

As further illustrated in FIG. 7F, top half-bridge 802a of back-end 828b of AC-to-DC converter 110a may comprise top primary switch 810a connected between nodes 8D and 8F, and top secondary switch 810b, which may be complementary to switch 810a and may be connected between node 8D and neutral N. Top half-bridge 802a of back-end 828b may further comprise bottom primary switch 812a, which may be connected between node 8E and neutral N, and bottom secondary switch 812b, which may be complementary to switch 812a and may be connected between nodes 8E and 8G. Furthermore, a top secondary capacitor 806c may be connected in parallel to a pair of switches 810a/810b between node 8F and neutral N, and a bottom secondary capacitor 806d may be connected in parallel to a pair of switches 812a/812b between node 8G and neutral N.

Similarly, bottom half-bridge 802b of back-end 828b of AC-to-DC converter 110b may comprise top primary switch 810c connected between nodes 8D′ and 8F′, and top secondary switch 810d, which may be complementary to switch 810c and may be connected between node 8D′ and neutral N. Bottom half-bridge 802b of back-end 828b may further comprise bottom primary switch 812c connected between node 8E′ and neutral N, and bottom secondary switch 812d, which may be complementary to switch 812c and may be connected between nodes 8E′ and 8G′. Furthermore, a top secondary capacitor 806e may be connected in parallel to a pair of switches 810c/810d between node 8F′ and neutral N, and a bottom secondary capacitor 806f may be connected in parallel to a pair of switches 812c/812d between node 8G′ and neutral N.

It may be appreciated that high-side line 826a and low-side line 826b of AC-to-DC power converter 110a may be connected to high-side line 826c and low-side line 826d of AC-to-DC converter 110b, respectively.

As further illustrated in FIG. 7F, top half-bridge 822a of DC-to-DC converter 120 may comprise top primary switch 814a connected between nodes 8H and 8I, top secondary switch 814b, which may be complementary to switch 814a and may be connected between node 8I and neutral N. Similarly, bottom half-bridge 822b of DC-to-DC converter 120 may further comprise bottom primary switch 816a connected between node 8J and neutral N, and bottom secondary switch 816b, which may be complementary to switch 816a and may be connected between nodes 8J and 8K.

Furthermore, in an embodiment schematically illustrated in FIG. 7F, top half-bridge 822a of DC-to-DC converter 120 may comprise first residual current sensor 818a, which may be connected between nodes 8I and 8M, and second residual current sensor 818b, which may be connected between nodes 8J and 8P. Top half-bridge 822a of DC-to-DC converter 120 may further comprise primary inductor 808e, which may be connected in series with residual current sensor 818a and may be connected between nodes 8I and 8M, and secondary inductor 808f, which may be connected in series with residual current sensor 818b and may be connected between nodes 8J and 8P. DC-to-DC converter 120 may also comprise capacitor 806g, which may be connected in series with inductors 808e/808f and in parallel to switches 814a/814b and switches 814c/814d, i.e., between nodes 8M and 8P. Furthermore, node 8M may be comprise a connection to positive DC+ terminal of an EV battery 190, and node 8P may be comprise a connection to negative DC-terminal of an EV battery 190.

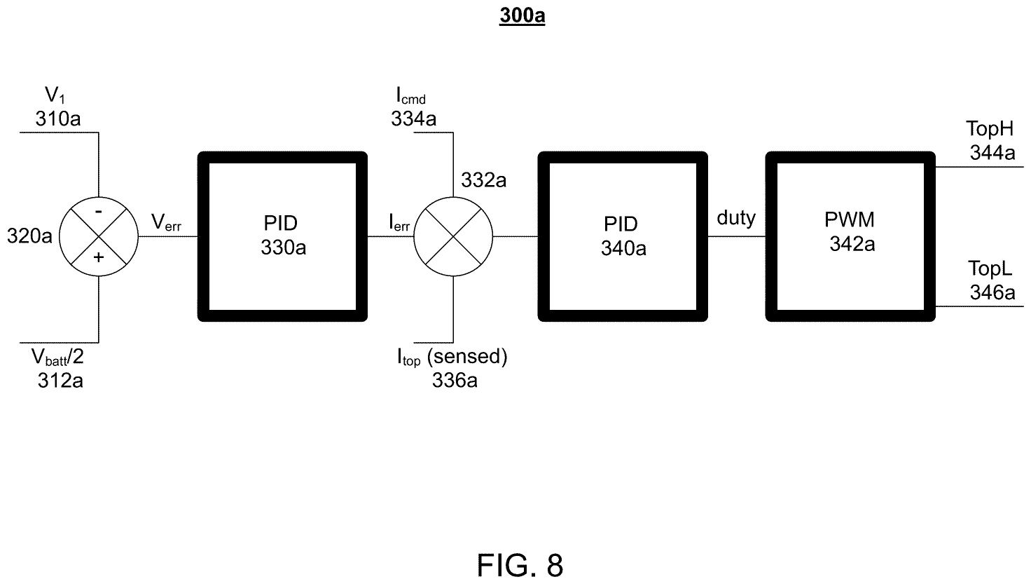

Turning now to FIG. 8, a controller for one half-bridge of a DC-to-DC converter 120 in a non-isolated battery charger 100 is indicated generally by the reference numeral 300a. The controller 300a may include a primary voltage signal (V₁) input 310a and a half-bridge battery input signal (V_{batt}/2). A voltage junction 320a provides V_{batt}/2 minus V₁ as a voltage error signal (Vₑᵣᵣ) to a primary proportional-integral-derivative (PID) controller 330a, which, in turn, provides a current error signal (Iₑᵣᵣ) to a current junction 332a. The current junction also receives a current command signal (I_{cmd}) and a sensed current (Iₜₒₚ) and connects the resultant signal to a secondary PID controller 340a.

The secondary PID controller 340a may provide a duty cycle signal to a pulse-width modulation (PWM) modulator 342a, which, in turn, may provide a top high control signal (TopH) via an output terminal 344a to control the top primary switch 224a, and a top low control signal (TopL) via an output terminal 346a to control the top secondary switch 226a. For example, the switches 224a and 226a may be controlled in a substantially complimentary configuration, where one is substantially off while the other is substantially on, without limitation thereto.

It will be appreciated that the comparison of V₁ to V_{batt}/2 or Vₑᵣᵣ and the use of the PID 330a is an example of a controller associated with a residual current sensor that provides an adjustment signal, in this case, Iₑᵣᵣ. Likewise, components 332a, 340a and 342a are an example of part of a control system for the power switches of the non-isolated AC-to-DC power converter.

It will be appreciated that the adjustment signal is actively adjusting the instantaneous voltage delivered to the EV in a manner that counteracts what is measured as residual current. While this countering may be used to prevent the GFCI from “tripping” due to the apparent residual current caused by ripples and other fluctuations in the DC power delivered to the EV, in the case of an actual fault, the risk of harm to a person touching the car as illustrated in FIG. 2 is reduced. For example, if the positive DC terminal connected to the EV were to be shorted to the EV's body, thus presenting hundreds of volts on the conductive body, current passing through the EV's body, that is relatively well insulated from ground by its rubber tires, may preferentially pass through the person to ground if the person is the path of least resistance. Such current would reduce the return current in comparison to the forward current. The response of the charger 100 to the resulting adjustment signal is to drop the voltage passing into the car. Because the residual current in this case is an actual fault to ground, this adjustment is not a very short-lived adjustment, but instead would result in the adjustment signal continuously causing the forward voltage to drop until the current passing through the person is well below the permitted threshold of, say, 20 mA of AC current and 6 mA DC current. Alternatively, the controller 145 can detect the difference between compensation for ripple in the DC supply to the battery or short-lived changes in residual current and longer duration residual currents resulting from a ground fault, and then, in the case of a ground fault being detected by the controller 145, signal to the charger 100 to stop charging and enter into a warning state to have the operator check for a ground fault.

Therefore, in some embodiments, the controlled charger 100 may never be capable of producing DC charge power that would ever trip the GFCI 180 because it would effectively shut down before that could happen. The GFCI 180 may, therefore, be a failsafe in the case of failure of the control mechanism of the charger 100. Alternatively, the degree of adjustment of the DC power going into the EV may be limited to compensate only for the non-uniformity of the DC power, for example, by limiting its ability to adjust instantaneously the voltage supplied by only +/− a given percentage, and the GFCI may be relied upon when this adjustment is insufficient.

The controller 300a may include a primary PID controller responsive to a battery voltage and a difference voltage; a secondary PID controller responsive to the primary PID controller, a command current and a difference current; and a pulse-width modulation (PWM) modulator responsive to the battery voltage, the difference voltage, the command current, and the difference current.

In an embodiment, where the above controller 300a is applied to one half bridge of the converter 200, a comparable “b” controller may be independently applied to the other half bridge of the converter 200. For example, where the controller 300a controls the switches 224a and 226a of the top half bridge, the comparable controller may independently control the switches 224b and 226b of the bottom half bridge, without limitation thereto. Substantially duplicate description may be omitted.

In an embodiment, where the above controller 300a is applied to one of either the top half bridge or the bottom half-bridge of the converter 200, it may be time-shared between the top half bridge and the bottom half bridge, without limitation thereto. Such time sharing may be substantially equal or may be biased towards one half bridge depending upon actual and/or predicted signal ripple. For example, the controller 300a may control the switches 224a and 226a during odd periods and control the switches 224b and 226b during even periods, without limitation thereto.

In an embodiment, where the above controller 300a is applied to one half bridge of the converter 200, a comparable controller for another half bridge, and/or potentially the other half bridge itself, may be omitted. For example, a positive terminal of the battery 290 may be connected to the secondary inductor 234a, and a negative terminal of the battery 290 may be connected to signal ground, without limitation thereto.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. A bidirectional electric vehicle (EV) battery charger comprising:
at least two non-isolated AC-to-DC power converters, each of said at least two non-isolated AC-to-DC power converters connectable to a respective phase of an AC mains and configured to provide an EV charging DC output having power switches controlled to be responsive to a charge voltage reference signal and an adjustment input to produce the EV charging DC output on a positive terminal and a negative terminal with a reference to ground;
a residual current sensor configured to measure at least one of a current difference between current flowing through said positive terminal versus current flowing through said negative terminal, or a voltage difference between a voltage across said positive terminal and said negative terminal versus a voltage across at least one of said positive terminal or said negative terminal and a chassis ground; and
a controller connected to said residual current sensor and to said at least two non-isolated AC-to-DC power converters and configured to provide an adjustment signal to an adjustment input in response to said residual current sensor measurement,
wherein said controller in combination with said at least two non-isolated AC-to-DC power converters are configured, when said EV charging DC output is connected to an EV, to prevent a current difference between current flowing through said positive terminal and current flowing through said negative terminal from exceeding a predetermined threshold associated with a ground fault circuit interrupter (GFCI) device connectable to said EV charging DC output.

2. The charger as defined in claim 1, wherein said adjustment input is associated with control of power switches in each of said at least two non-isolated AC-to-DC power converters.

3. The charger as defined in claim 1, wherein said at least two non-isolated AC-to-DC power converters comprise, at an output stage, at least one DC-to-DC power converter, and said adjustment input is associated with control of power switches in said DC-to-DC power converter.

4. The charger as defined in claim 3, wherein said at least one DC-to-DC power converter comprises a PWM controller responsive to at least one current or voltage sensor, a reference signal, and said adjustment signal.

5. The charger as defined in claim 3, wherein said DC-to-DC power converter comprises a positive half-bridge and a negative half-bridge.

6. The charger as defined in claim 5, wherein said adjustment signal is configured to adjust a duty cycle of power switches associated with one of said positive half-bridge or said negative half-bridge.

7. The charger as defined in claim 5, wherein said positive half-bridge and said negative half-bridge comprise at least one coupled inductor.

8. The charger as defined in claim 7, wherein said at least one coupled inductor comprises:
a positive bridge primary inductor connected in series with a positive bridge secondary inductor to the positive output terminal; and
a negative bridge primary inductor connected in series with a negative bridge secondary inductor to the negative output terminal.

9. The charger as defined in claim 8, wherein said at least one coupled inductor further comprises:
a positive bridge tertiary inductor having a first terminal connected between the positive bridge primary inductor and the positive bridge secondary inductor, and having a second terminal connected to signal ground; and
a negative bridge tertiary inductor having a first terminal connected between the negative bridge primary inductor and the negative bridge secondary inductor and having a second terminal connected to signal ground.

10. The charger as defined in any claim 1, further comprising said ground fault circuit interrupter (GFCI) device connected to said EV charging DC output and operative to disconnect said at least two non-isolated AC-to-DC power converters from an EV when a current difference between current flowing through said positive terminal and current flowing through said negative terminal exceeds a predetermined threshold associated with a ground fault.

11. The charger as defined in claim 10, wherein said predetermined threshold is about 20 mA.

12. The charger as defined in any claim 1, wherein said AC mains is a split-phase system comprising two voltage waveforms 180 degrees out of phase.

13. The charger as defined in any claim 1, wherein said AC mains is a two-phase system comprising two voltage waveforms that are 180 degrees out of phase.

14. The charger as defined in any claim 1, wherein said AC mains is a three-phase system comprising three voltage waveforms that are 120 degrees out of phase.

15. An electric vehicle (EV) comprising an AC charge port connectable to a split-phase power cable and the bidirectional EV battery charger as defined in claim 1 connected on an AC side to said AC charge port and at said DC output to a battery of said EV.
